(19) United States
(12) Patent Application Publication
(10) Pub. No.: US 2013/0063477 A1
(43) Pub. Date: Mar. 14, 2013

(54) SYSTEMS AND METHODS FOR USING A MOVABLE OBJECT TO CONTROL A COMPUTER

(71) Applicants: James Richardson, Corvallis, OR (US); Birch Zimmer, Corvallis, OR (US); Eric Wesley Davison, Issaquah, WA (US)

(72) Inventors: James Richardson, Corvallis, OR (US); Birch Zimmer, Corvallis, OR (US); Eric Wesley Davison, Issaquah, WA (US)

(21) Appl. No.: 13/468,982

(22) Filed: May 10, 2012

Related U.S. Application Data
(63) Continuation-in-part of application No. 11/296,731, filed on Dec. 6, 2005, now Pat. No. 8,179,366.
(60) Provisional application No. 60/633,833, filed on Dec. 6, 2004.
(60) Provisional application No. 60/633,839, filed on Dec. 6, 2004.

(51) Int. Cl. G09G 5/00

(52) U.S. Cl. 345/619; 345/156

(57) ABSTRACT

A method from controlling a computer is disclosed. The method includes receiving position data defining an actual position of a sensed object, applying a first scaling profile to the position data. The first scaling profile includes at least one scaling curve defining a relationship between the actual position relative to a virtual position in a rendered scene within an application program executed on the computer. The scaling curve defines a range of actual positions of the sensed object relative to a range of changes in virtual position. The method further includes controlling display of the rendered scene according to the first scaling profile, where changes in actual movement of the sensed object generate corresponding scaled movement of the virtual position in the rendered scene.

### CROSS REFERENCE TO RELATED APPLICATIONS

The present application is a continuation-in-part of U.S. Utility patent application Ser. No. 11/296,731, filed Dec. 6, 2005, titled “Systems and Methods for Using a Movable Object to Control a Computer”, which claims priority to U.S. Provisional Patent Application Ser. No. 60/633,833, filed Dec. 6, 2004, titled “Position Sensing Apparatus and Software, Systems and Methods for Using a Movable Object to Control a Computer” and to U.S. Provisional Patent Application Ser. No. 60/633,839, filed Dec. 6, 2004, titled “Position Sensing Apparatus and Software, Systems and Methods for Using a Movable Object to Control a Computer” the entire contents of each of which are incorporated herein by reference in their entirety and for all purposes.

### TECHNICAL FIELD

The present description relates to systems and methods for using a movable object to control a computer.

### BRIEF DESCRIPTION OF THE DRAWINGS

FIG. 1 is a schematic block diagram depiction of a system for controlling a computer based on position and/or movement of a movable object.

FIG. 2 depicts a frame of reference and an apparatus for affixing sensed locations to a user's head, to enable tracking of movements of the user's head.

FIG. 3 is a schematic depiction of another system for controlling a computer based on position and/or movement of a movable object.

FIGS. 4 and 5 depict exemplary two dimensional mapping representations of the positions of three sensed locations of a movable object within three dimensional space.

FIG. 6 depicts an exemplary method for processing positional data received from a position sensing apparatus, in order to generate commands for controlling a computer.

FIGS. 7A-7D depict various exemplary correlations between actual position of a movable object and a corresponding virtual position of a virtual object or rendered scene within a computer, such as within a virtual reality computer game.

FIGS. 8-10 are exemplary screenshots and depictions of interface tools configured to enable a user to understand and adjust correlations between movement of a movable object and the resultant corresponding control that is exerted over a computer based on the movement.

FIG. 11 shows an example embodiment of a profile for controlling a relationship between actual movement of a sensed object and corresponding virtual movement in a rendered scene.

FIG. 12 shows an example embodiment of a graphical user interface for providing manipulation of a profile.

FIGS. 13-15 show example embodiments of representations of scaling curves.

FIGS. 16-17 show an example embodiment of a graphical user interface including a first-person virtual world viewing window of virtual movement of a sensed object.

FIG. 18 shows an example embodiment of a graphical user interface including a third-person virtual world viewing window of virtual movement of a sensed object.

FIG. 19 shows an embodiment of a method for controlling a computer.

FIG. 20 shows another embodiment of a method for controlling a computer.

### DETAILED DESCRIPTION

The present description is directed to software, hardware, systems and methods for controlling a computer (e.g., controlling computer hardware, firmware, a software application running on a computer, etc.) based on the real-world movements of an operator's body or other external object. The description is broadly applicable, although the examples discussed herein are primarily directed to control based on movements of a user's head, as detected by a computer-based position sensing system. More particularly, many of the examples herein relate to using sensed head movements to control a virtual reality software program, and still more particularly, to control display of virtual reality scenes in a “fishtank VR” type application, such as a game used to simulate piloting of an airplane, or other game or software that provides a “first person” view of a computerized scene.

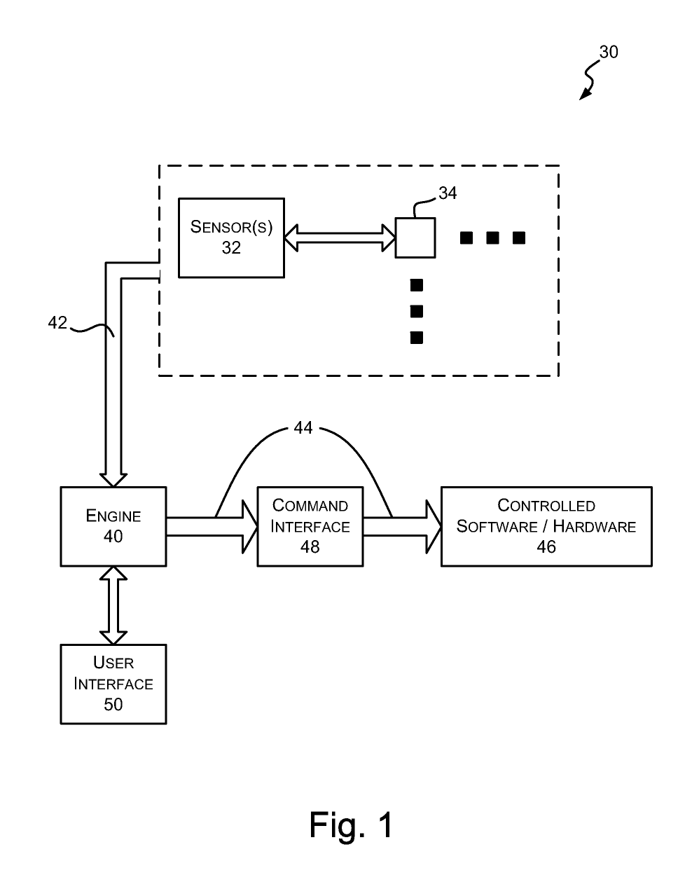

FIG. 1 schematically depicts a motion-based control system 30 according to the present description. A sensing apparatus, such as sensor or sensors 32, is responsive to, and configured to detect, movements of one or more sensed locations 34, relative to a reference location or locations. According to one example, the sensing apparatus is disposed or positioned in a fixed location (e.g., a camera or other optical sensing apparatus mounted to a display monitor of a desktop computer). In this example, the sensing apparatus may be configured to sense the position of one or more sensed locations on a sensed object (e.g., features on a user's body, such as reflectors positioned at desired locations on the user's head).

According to another embodiment, the sensing apparatus is positioned on the sensed object. For example, in the setting discussed above, the camera (in some embodiments, an infrared camera may be employed) may be secured to the user's head, with the camera being used to sense the relative position of the camera and a fixed sensed location, such as a reflector secured to a desktop computer monitor. Furthermore, multiple sensors and sensed locations may be employed, on the moving object and/or at the reference location(s).

In the above example embodiments, position sensing may be used to effect control over rendered scenes or other images displayed on a display monitor positioned away from the user, such as a conventional desktop computer monitor or laptop computer display. In addition to or instead of such an arrangement, the computer display may be worn by the user, for example in a goggle type display apparatus that is worn by the user. In this case, the sensor and sensed locations may be positioned either on the user's body (e.g., on the head) or in a remote location. For example, the goggle display and camera (e.g., an infrared camera) may be affixed to the user's head, with the camera configured to sense relative position between the camera and a sensed location elsewhere (e.g., a reflective sensed location positioned a few feet away from the user). Alternatively, a camera or other sensing apparatus may be positioned away from the user and configured to track/sense one or more sensed locations on the user's body. These sensed locations may be on the goggle display, affixed to some other portion of the user's head. etc.

Sensing apparatus 32 typically is operatively coupled with engine software 40, which receives and acts upon position signals or positional data 42 received from sensing apparatus 32. Engine software 40 receives these signals and, in turn, generates control signals 44 which are applied to effect control over controlled software/hardware 46 (e.g., a flight simulation program), which may also be referred to as the “object” or “objective of control.” Various additional features and functionality may be provided by user interface 50, as described below.

The object of control may take a wide variety of forms. As discussed above, the object of control may be a first person virtual reality program, in which position sensing is used to control presentation of first person virtual reality scenes to the user (e.g., on a display). Additionally, or alternatively, rendering of other scenes (i.e., other than first person scenes) may be controlled in response to position. Also, a wide variety of other hardware and/or software control may be based on the position sensing, other than just rendering of imagery.

Continuing with FIG. 1, in some embodiments, the various depicted components may be provided by different vendors. Accordingly, in order to efficiently facilitate interoperability, it may be desirable to employ components such as command interface 48, to serve as translators or intermediaries between various components. Assume, for example, that the object of control is a video game that has been available for many years, with an established set of control commands that control panning/movement of scenes and other aspects of the program. Assume further that it was originally intended that these control commands be received from a keyboard and mouse of a desktop computer. To employ the motion control described herein with such a system, it may be desirable to develop an intermediary, such as command interface 48, rather than performing a significant modification to engine software 40. The intermediary would function to translate the output of engine software 40 into commands that could be recognized and used by the video game. In many embodiments, the design of such an intermediary would be less complex than the design of engine 40, allowing the motion control system to be more readily tailored to a wide range of existing games/programs.

The functionality and interrelationship of the above components may be readily understood in the context of an aviation simulation software program. Typically, aviation simulators include a first person display or other rendered scene of the airplane cockpit, along with views through the cockpit windows of the environment outside the simulated airplane. An exemplary configuration of the described system may be employed as follows in this context: (1) an infrared camera may be mounted to the computer display monitor, and generally aimed toward the user's head; (2) the camera may be configured to detect and be responsive to movements of various sensed locations on the user's head, such as reflective spots affixed to the user's head, recognizable facial features, etc.; (3) the raw positional data obtained by the camera would be applied to engine software 40 (e.g., in the form of signals 42), which in turn would produce control signals that are applied to controlled software/hardware 46, which in this case would be the software that generates the rendered scenes presented to the user, i.e., the actual flight simulator software.

In this example, the flight simulator software and motion-control system may be supplied by different vendors/developers, as discussed above In the case of a third-party developer of the position sensing apparatus and engine software, the engine software would be specially adapted to the particular requirements of the controlled software. For example, a given flight simulator program may have a standard set of tasks that are performed (e.g., move the depicted virtual reality scene to simulate translation and rotation). The engine software would be adapted in this case to convert or translate the raw positional data into the various tasks that are performed by the flight simulator program. For example, movement of the sensed object in a first direction may correlate with task A of the flight simulator; movement of the sensed object in a second direction with task B, etc. Typically, in implementations of a virtual reality program such as a flight simulator, movements of the user's head would be used to control corresponding changes in the cockpit view presented to the user, to create a simulation in which it appears to the user that they are actually sitting in a cockpit of an airplane. For example, the user would rotate their head to the left to look out the left cockpit window, to the right to look out the right cockpit window, downward to look directly at a lower part of the depicted instrument panel, etc.

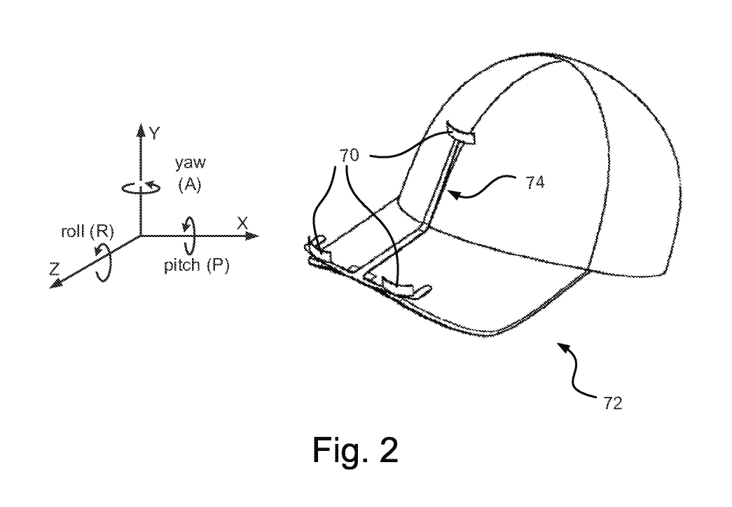

FIG. 2 depicts an example in which sensed locations or reflective members 70 are disposed on a cap 72 to be worn by the user. As shown in the figure, the reflective spots are provided on a member 74 which may be clipped to a brim of the cap. Any desired number of reflective locations may be employed. In the present example, three reflective locations are used. The location of the reflective spots relative to a fixed location may be determined using an infrared camera. The use of reflective spots and an infrared camera is exemplary only—other types of cameras and sensing may be employed. Indeed, for some applications, non-optical motion/position sensing may be employed in addition to or instead of cameras or other optical methods.

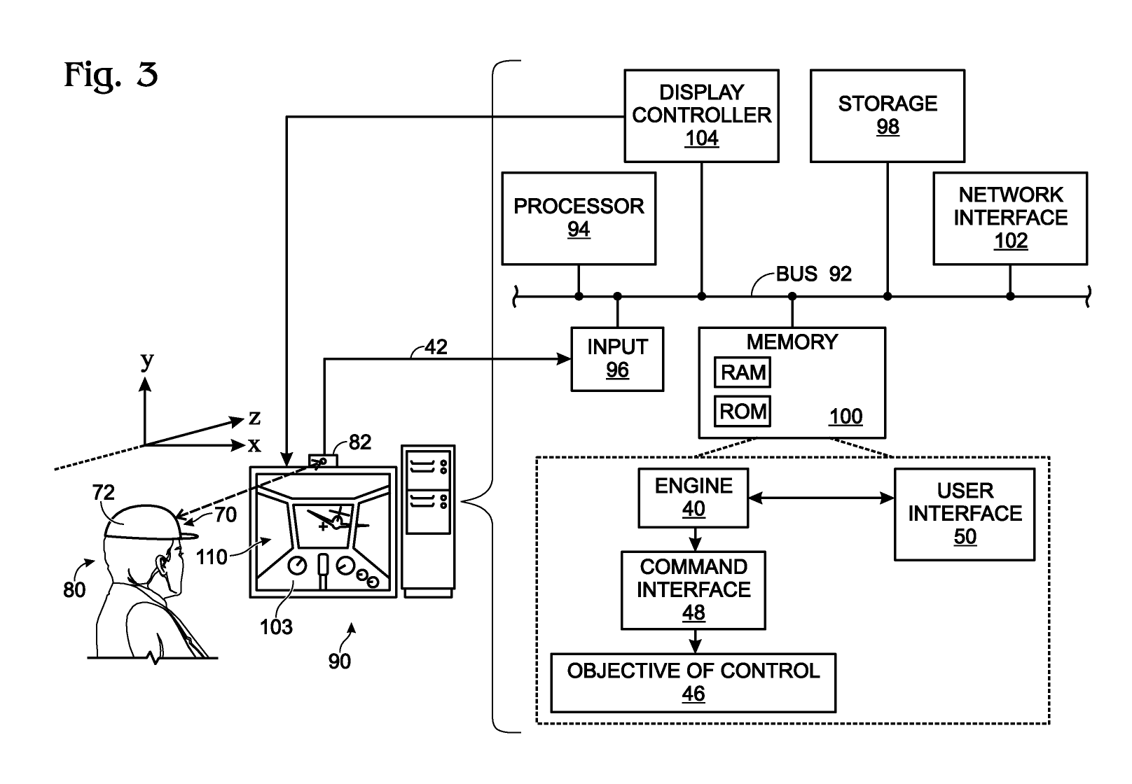

In the present example, the camera may be mounted to a display monitor of the computer that is to be controlled. The positional data received by the camera is received into the engine software, which may be executed within a memory location of the computer to be controlled. FIG. 3 also shows sensed locations 70 and cap 72, and depicts the physical relationship between the sensed object (e.g., the user's head 80) and the sensing apparatus (e.g., infrared camera 82), and further provides a schematic depiction of the engine software and computer to be controlled based on movements of the sensed object. In FIG. 3, and in other examples discussed herein, the motion sensing methods and systems may be used to control presentation of a rendered scene 110 to the user. FIG. 3 depicts a desktop monitor 103 displaying the rendered scene, though it will be appreciated that other types of displays may be employed, including the goggle apparatus discussed above.

Any type of computer may be employed in connection with the present description. The computer may include some or all of the components of the exemplary computing device depicted schematically in FIG. 3. Specifically, computer 90 may include various components interconnected via a bus 92 or similar mechanism, such as a processor 94, input peripherals 96, storage 98, memory 100, network interface 102, etc. In the present example, the display monitor 103 to which camera 82 is affixed is driven by the display controller 104. Camera 82 serves as an input peripheral, in that it receives external positional data and applies it to the computer for processing. In many embodiments, a position sensing apparatus such as a camera will be one of many input devices. Other input devices may include a mouse, keyboard, etc. In the depicted example, the positional data is received into engine software 40 (e.g., from camera 82 via input 96 and bus 92), which may be executed within memory 100. The engine software, in turn, processes the positional data in order to effect control over some other part of the computer. In the present example, controlled software 46 is controlled at least in part by the engine software. As indicated, the controlled software may also be executed within the memory of the computer. The controlled software may be a flight simulator program or other type of virtual reality software program. In the present example, position sensing is used to control presentation of displayed images 105, which may be first person virtual reality scenes or other rendered images.

Referring again to FIG. 2, the figure also depicts a frame of reference that may be used to describe translational and rotational movement of the user's head or other sensed object. Assuming an infrared camera mounted on top of a computer display, assume the Z axis represents translation of the user's head linearly toward or away from the computer display point of reference. The X axis would then represent horizontal movement of the head relative to the reference, and the Y axis would correspond to vertical movement. Rotation of the head about the X axis is referred to as “pitch” or P rotation; rotation about the Y axis is referred to as “yaw” or A rotation; and rotation about the Z axis is referred to as “roll” or R rotation.

In embodiments such as that of FIG. 2, in which three sensed locations are employed, the positional data that is obtained (e.g., by the camera) may be represented within engine software 40 initially as three points within a plane. In other words, even though the sensed object (the user's head) is translatable in three rectilinear directions and may also rotate about three rectilinear axes, the positions of the three sensed locations may be mapped into a two-dimensional coordinate space. As explained below, the position of the three points within the mapped two-dimensional space may be used to determine relative movements of the sensed object (e.g., a user's head in the above example).

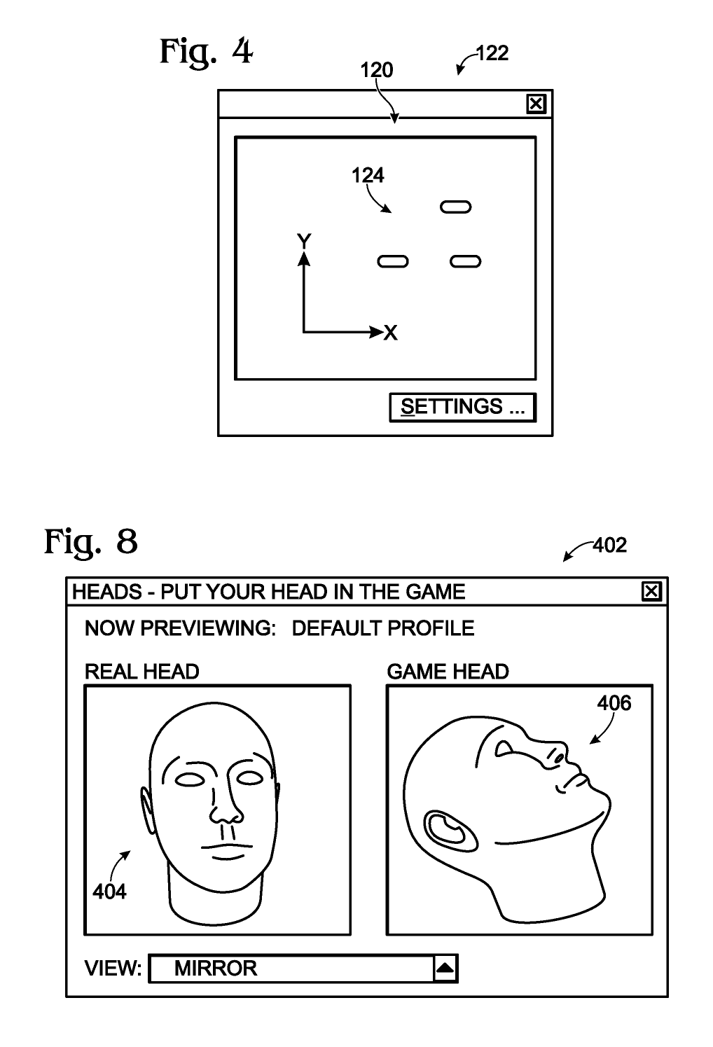

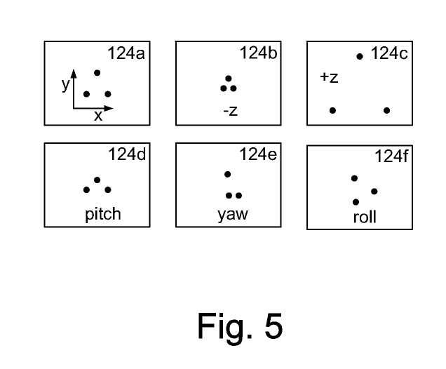

FIG. 4 depicts an exemplary screen shot 120 of a software embodiment 122 depicting a two-dimensional mapping 124 based on detection of three sensed locations on a sensed object. FIG. 5 depicts six different mappings to illustrate how movement in each of the six degrees of freedom (X, Y and Z axis translation, and rotation about the X, Y and Z axes) affects the two dimensional mapping 124. Referring first to the upper left mapping 124a, a neutral mapping is depicting, corresponding to a centered reference location of the sensed object and sensed locations. For example, this reference position may correspond to the user's head being in a centered position, relative to a camera mounted atop the display monitor, with the user more or less squarely facing the monitor. In this example, the computer monitor would be in the X-Y plane. Thus, translational movements of the user's head (and sensed locations) along the X and/or Y axes would result in the mapped spots shifting as indicated by the arrows in the upper left mapping. Various other movements are indicated in the other mappings of FIG. 5. Specifically, mapping 124b indicates negative Z-axis translation relative to the neutral position of mapping 124a; mapping 124c shows positive Z-axis translation; mapping 124d shows pitch rotation; mapping 124e shows yaw rotation; and mapping 124f shows roll rotation.

In some cases, it will be desirable to employ sensing methodologies and systems that result in certain indeterminacies in the raw positional data that is initially obtained. For example, in the above example, the two-dimensional mapping of the three sensor spots can yield multiple solutions when equations are applied to determine the position of the sensed object. This is partially due to the fact that, in the present example, the three sensor spots are not differentiated from each other within the mapping representation of the raw data. Referring, for example, to mapping 124a (FIG. 5), the mapping could correspond to three different rotational positions about the Z axis, each being roughly 120 degrees apart. Moreover, in the six-degrees-of-freedom system described herein, the described three-sensor approach can yield six solutions when certain computational methods are applied to the raw data.

The two-dimensional mapping may thus be thought of as a compressed data representation, in which certain data is not recorded or represented. This compression-type feature allows the system to be simpler, to operate at higher speeds under certain conditions, and to operate with fewer sensors. Accordingly, the system typically is less costly in terms of the processing resources required to drive the data acquisition functionality of the engine software 40.

Various methods may be employed to address these indeterminacies. For example, calculations used to derive actual movements from variations in the two-dimensional mapping may be seeded with assumptions about how the sensed object moves. For example, a user's head has a natural range of motion. From the neutral position described above (and using the same frame of reference), a human head typically can “yaw” rotate 90 degrees to either side of the neutral position. Similarly, typical range of head rotation is also approximately 180 degrees or less about each of the “pitch” and “roll” axes. Thus in certain exemplary applications, it may be assumed that the user is upright and generally facing the display monitor, such that solutions not corresponding to such a position may be eliminated.

Furthermore, temporal considerations may be employed, recognizing that the human head moves in a relatively continuous motion, allowing recent (in time) data to be used to make assumptions about the movements producing subsequent data. Regardless of the specific methodology that is employed, the methods are used to rule out impossible (or improbable or prohibited or less probable) and thereby aid in deriving the actual position of the movable object. More generally, use of constraints may be employed with any type of movable object being sensed. Such techniques are applicable in any position sensing system where the data is compressed or represented in such a manner as to provide non-unique solutions.

The following are examples of empirical considerations that may be built into the described systems and methods to resolve the position of the sensed object:

Based on empirical observations of multiple users, it could be determined that a typical user takes time T to fully rotate their head (yaw rotation) through the full range of yaw rotation, which could be expressed in terms of an angular velocity. Thus, if the rotational position at time t0 is known, a solution or solutions existing at time t1 could be ruled out if they correspond to a rotational change that would require rotation at an angular velocity greater than that which had been observed.

Solutions corresponding to unnatural or unlikely positions can be ruled out based on information (empirical or otherwise) about the range of motion of the sensed object.

Positional solutions may be ruled out based on current conditions associated with the controlled computer software/hardware. For example, in a flight simulator game, assume that the simulated plane is being taken through a landing sequence, and that the head position has been resolved down to two possible solutions. If one solution corresponds to the user looking at the landing runway, and another corresponds to the user looking out the left cockpit window, then, absent other information, the position corresponding to the user being focused on the landing task would be selected.

It should be appreciated that any combination of constraints, empirical information, contextual considerations, etc. may be employed to resolve ambiguities in the positional data.

It may be desirable in certain settings to employ additional sensed locations. For example, in the described example, if one of the three sensors were obstructed or otherwise unavailable, an alternate sensed location could be employed. Thus, the system may be configured so that any given time, the position is being sensed using three sensors, however, more than three sensed locations are available, in the event that one or more of the sensed locations is occluded or otherwise unavailable.

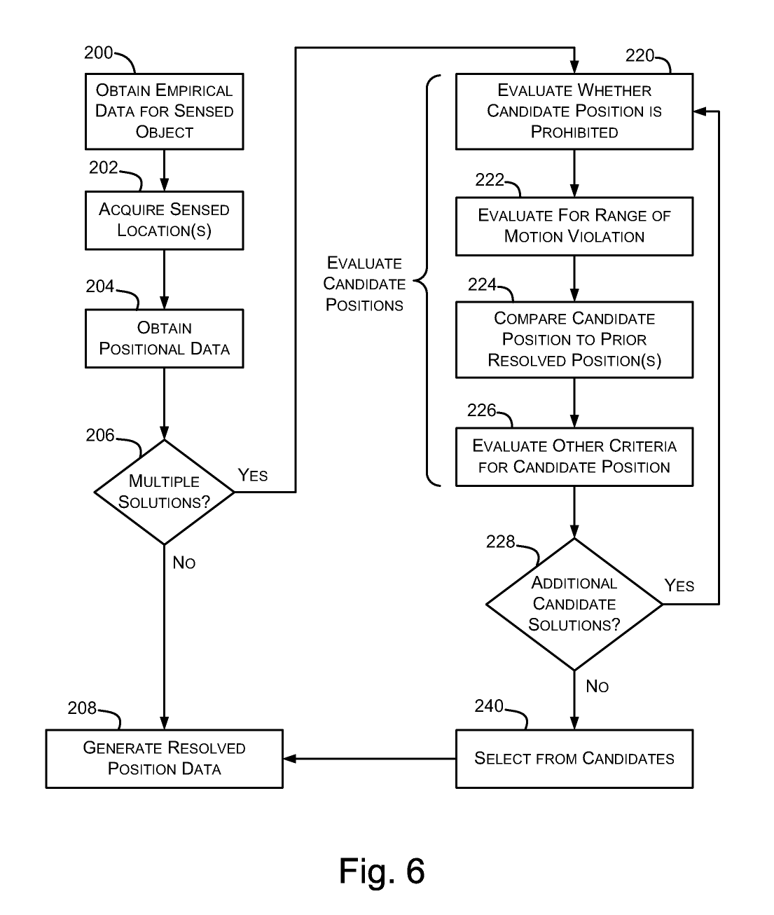

FIG. 6 depicts an exemplary method for resolving positional data. As shown at 200, the method may include acquiring data pertaining to the movable object which is to be sensed. This may occur during design of the system, during a setup routine performed by the user, during the course of normal operation, or at any other desirable or practicable time. The data may be empirically acquired and may include information about the range of motion of the movable object, about the velocity at which the object translates and/or rotates, positional probabilities, etc. With regard to positional probability, empirically acquired data may reveal that the object is in a first set or range of positions a relatively large percentage of the time, and that another set/range of positions, while occurring with some frequency, occur much less often than the positions of the first set. This information may aid in selecting between plural solutions. The above discussion is exemplary only—a wide variety of empirical information may be gathered to aid in resolving ambiguities in the positional data.

The method may also include, as shown at 202, acquiring a sensed location or locations. This may include various routines for verifying that the sensing apparatus is properly detecting the sensed locations, and/or for verifying that the proper number of sensed locations are available (e.g., that a sensed location is not occluded or obstructed). Accordingly, given the possibility in some settings of having an unavailable sensed location (e.g., due to obstruction), it may be desirable in some applications to provide redundancy or more sensed locations than is needed. For example, member 74 (FIG. 2) may be provided with an additional reflective spot, i.e., four reflectors instead of three. Continuing with this example, the method may thus include, in the event that one of the reflective spots is unavailable, acquiring an alternate reflector (the fourth, redundant reflector). Thus, even though a given system embodiment may be configured to employ X number of sensors (three in the present example), any practicable number of additional sensors may be employed in the event that one is unavailable (e.g., unobstructed, in a poor position, etc.).

Continuing with FIG. 6, the method may also include, at 204, acquiring the raw positional data. In the example of FIG. 3, camera 82 would sense the raw positional data and the data would be received into engine software 40. At 206, the method may include assessing whether the raw positional data yields multiple solutions, corresponding to different resolved positions for the movable object. If only one solution exists, the position is resolved (selected) as shown at 208.

If multiple solutions are present, the different candidate solutions may then be evaluated to resolve the positional data by selecting one of the multiple solutions. As indicated above, many methods may be employed to select from the multiple candidate solutions. According to one example, each candidate solution is evaluated using various criteria. As shown in the figure, a given candidate position may be evaluated to determine if it is prohibited (220), for example, via inclusion in a list of enumerated prohibitions or a range of prohibited positions. The candidate position may also be evaluated to see if it corresponds to a position that is outside the observed/permitted range of motion, or if the range of motion renders the positions highly unlikely, etc. (222). The candidate position may be compared to prior resolved positions (224), in order to yield temporal or other types of analyses. For example, given two possible candidate positions, it may be desirable to select the candidate that is closest to the most recent resolved position, particularly if only a short amount of time has passed since the last update, as it may be assumed that small positional changes are more likely to occur than large changes in a given time period. At 226, any other desirable/useful criteria may be assessed. If additional candidate solutions are present, a subsequent potential solution may then be evaluated, as shown at 228.

Once all the candidate positions have been evaluated, the method may include, as shown at 240, selecting from among the plural candidate positions in order to obtain a calculated, or resolved position upon which further control is based. Selection may be based on various combinations of the above assessments. Some candidates may be ruled out immediately during assessment (e.g., if a potential candidate solution represents a position that is impossible for the sensed object to achieve, or if a certain position is prohibited). Alternatively, it is possible that after all candidate positions have been assessed, multiple solutions still remain. In such a case, the assessment performed at one or more of the preceding assessments may be compared for different solutions in order to select the resolved solution. For example, the assessment may reveal that candidate A is much more likely to be the actual position then candidate B, and candidate A would therefore be selected as the resolved position. Preferences among multiple possibilities may be prioritized by scoring the various assessed parameters, or through other methods.

Note that the example control and method routines included herein can be used with various motion control configurations. The specific routines described herein may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, it should be appreciated that the method of selecting and employing one of multiple possible solutions is applicable to sensing apparatuses other than those employing a camera or other optical devices. Capacitors, gyroscope, accelerometers, etc. may be employed to perform the position sensing, for example. Also, it should be appreciated that the present systems and methods relating to resolving positional data are not limited to virtual reality video games, but are more widely applicable to any system in which the physical movements and/or position of an external object are used to control some aspect of a computer.

As previously discussed, position sensing systems have been employed to some extent in first person VR software applications. Typically, these VR applications seek to provide a one-to-one correspondence between actual movements and the simulated virtual movements. In other words, when the user rotates their body 90 degrees, the displayed virtual perspective within the game rotates by 90 degrees. This approach is common in VR games where displayed information is presented to the user via a “goggle-type” display that is mounted to the user's head.

By contrast, in implementations where actual and virtual movements are correlated, the present systems and methods typically employ actual-virtual movement relationships other than the one-to-one relationship described above. For example, in some configurations, rotational movements may be amplified or otherwise scaled, uniformly across the range of rotational motion, or as a function of rotational position, rotational velocity, etc. Such an approach is particularly useful when correlating actual and virtual movements of a head.

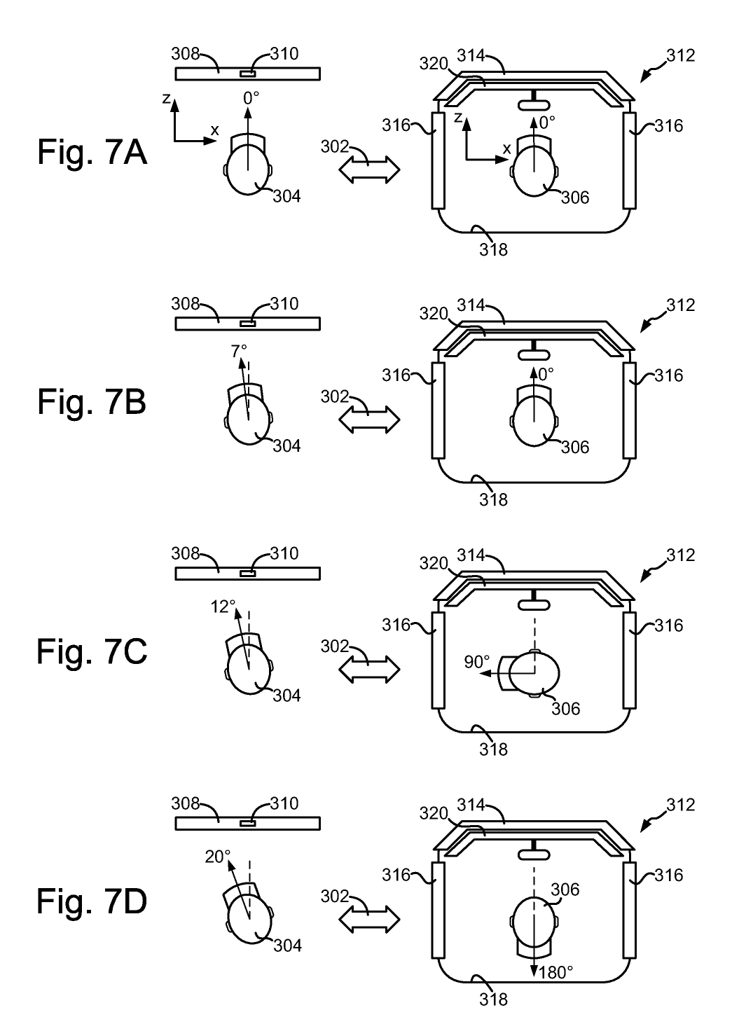

FIGS. 7A-7D provide an example of an environment in which scaling may be desirable. In a flight simulator, a non-scaled, non-amplified correlation between actual and virtual motion would require the user to rotate their head 90 degrees to the left to look squarely out the left-side virtual cockpit window. It would be difficult or impossible, however, for the user to keep their eyes on the computer display and see the displayed scene with their head rotated into that position. Accordingly, the figures show correlations 302, including non-scaled correlations, between the actual, real world position of a user's actual head 304 (on the left of the figures) and a corresponding position of a virtual head 306 in a first person software program, such as a flight simulator game.

The left side of each figure shows the actual head 304 of the user, in relation to a computer display monitor 308, which may display scenes from a flight simulator program. As previously discussed a sensor such as a camera 310, may be mounted on the computer display or placed in another location, and is configured to track movements of the user's head.

The right side of each figure shows a schematic representation which describes a state of the flight simulator software. In each of the figures, a virtual head 306 is disposed within virtual cockpit 312, which includes a front window or windshield 314, side windows 316, back 318 and instrument panel 320. The depicted states are as follows: (1) FIGS. 7A and 7D: the virtual head is facing directly forward (0°), such that the flight simulator software displays (e.g., on display monitor 308) a scene of instrument panel 320 and a view out through front window 314; (2) FIG. 7C: the virtual head is rotated 90° from the position shown in FIGS. 7A and 7B, such that the simulator software displays the left side of cockpit 312 and a view out the left side window 316; (3) FIG. 7D: the virtual head is rotated 180° from the position shown in FIGS. 7A and 7B, such that the simulator software displays back 318 of cockpit 312.

It should be understood that the depictions on the right side of the figures may or may not form part of the material that is displayed to the user of the software. In the present discussion, the depictions to the right serve primarily to illustrate the first-person orientation within the virtual reality environment, to demonstrate the correspondence between positions of the user's head (i.e., head 304) the virtual reality scene that is displayed to the user on display 308. However, the depictions on the right side may form part of the content that is displayed to the user. Indeed as discussed below, it may in some cases be desirable to display content that illustrates the correlation between actual movements and virtual movements, to enable the user to better understand the correlation, and in further embodiments, to control/adjust the relationship between actual and virtual movements.

Continuing with FIG. 7A, actual head 304 is depicted in a neutral, centered position relative to sensor 310 and display 308. The head is thus indicated as being in a 0° position (yaw rotation). As shown by correlation 302, the corresponding virtual position is also 0° of yaw rotation, such that the user is presented with a view of instrument panel 320 and a view looking through the front window 314 of cockpit 312. These scenes would be displayed on display 308.

FIG. 7B illustrates a rotational dead zone, or a range of actual rotation that produces no corresponding change in position of the virtual head. Specifically, in the figure, actual head 304 has undergone 7° of yaw rotation, though virtual head 306 remains in the 0° yaw position, as it was in FIG. 7A when the actual head had not yet rotated out of the neutral position. It may be desirable to intentionally configure the system in this manner, such that certain actual movements (e.g., movements in a certain range of motion, rapid jerky movements, small positional changes, etc.) produce no change in the virtual position, and thus no change in the scene that is presented to the user on display 308. Dead spots may be configured in various ways. For example, the user may want very slight movements centered about a neutral position to have no effect. If every small rotation or bobble of the user's head directly correlated to virtual motion (e.g., no dead spot), small movements could cause the displayed scene to have undesirable jitter or wobble. The system may also be configured with other types of non-responsiveness, for example to not respond to very high frequency, small amplitude movements.

FIG. 7C depicts an upward scaling, or amplification, of yaw rotation. In a flight simulator, a non-scaled, non-amplified correlation between actual and virtual motion would require the user to rotate their head 90 degrees to the left to look squarely out the left-side virtual cockpit window. In this orientation, however, it would be difficult or impossible for the user to keep their eyes on computer display 308 to view the displayed scene. Accordingly, in the example of FIG. 7C, a 12° yaw rotation of actual head 304 has produced a corresponding 90° rotation in the virtual head, such that the user is presented (on display 308) with a scene looking out left side window 316 of virtual cockpit 312. In such a configuration, the user is able to rotate their head to the left (thus simulating the real-life motion that would be required to look to the left out a window) so as to produce a corresponding change in the depicted scene. Here, 12° of yaw rotation produces a 90° rotation of the displayed scene. FIG. 7D similarly depicts amplification of yaw rotation, in which 20° of yaw rotation produces a 180° rotation of the displayed virtual reality scene, allowing the user to view back 318 of simulated cockpit 312.

It will be appreciated that a wide variety of correlations may be employed between the actual movement and the control that is effected over the computer. In virtual movement settings, correlations may be scaled, linearly or non-linearly amplified, position-dependent, velocity-dependent, acceleration-dependent, etc. Furthermore, in a system with multiple degrees of freedom or types of movement, the correlations may be configured differently for each type of movement. For example, in the six-degrees-of-freedom system discussed above, the translational movements could be configured with deadspots, and the rotational movements could be configured to have no deadspots. Furthermore, the scaling or amplification could be different for each of the degrees of freedom.

Because the actual movement and virtual movement may be correlated in so many different ways, and for other reasons, it may be desirable to employ different methods and features to enable the user to more readily the control produced by movements of the sensed object. Referring again to FIGS. 7A-7D, a legend such as that such in those figures may be employed. In typical configurations, user interface 50 (FIG. 3) would be configured to produce such legend, though this feature may be included as part of engine software 40, controlled software/hardware 46, or any other software component.

The depictions shown in FIGS. 7A-7D may be employed to demonstrate to the user a side-by-side comparison showing the actual position of the sensed object (e.g., the user's head) and the control that is effected over the computer. In other words, referring to FIGS. 7B, and to FIGS. 7C and 7D, the user is shown that relatively small yaw rotations (e.g., 7° or less) about a neutral position produce no corresponding movement, and further yaw rotation is amplified so that the user can rotate the virtual view 180° with relatively small yaw rotations of their head.

The software may thus be said to employ, in certain embodiments, an actual indicator and a virtual indicator, as respectively denoted by actual head 304 and virtual head 306 in the examples of FIGS. 7A-7D.

FIG. 8 depicts a further example of a software component or feature 402 including an actual indicator 404 and a virtual indicator 406. The figure continues with the previously-discussed example, in which movements of the user's actual head are sensed and produce a corresponding control of some virtual movement in the computer, such as movement of first-person virtual reality scenes displayed on monitor 308 (FIGS. 7A-7D). As shown, actual indicator 404 is a representation of the actual sensed position of the user's head, while virtual indicator 406 is a representation of the corresponding position of the virtual head. Accordingly, the displayed comparison would allow the user to easily ascertain what actual movement is required to rotate the virtual scene by 90°, 180°, etc.

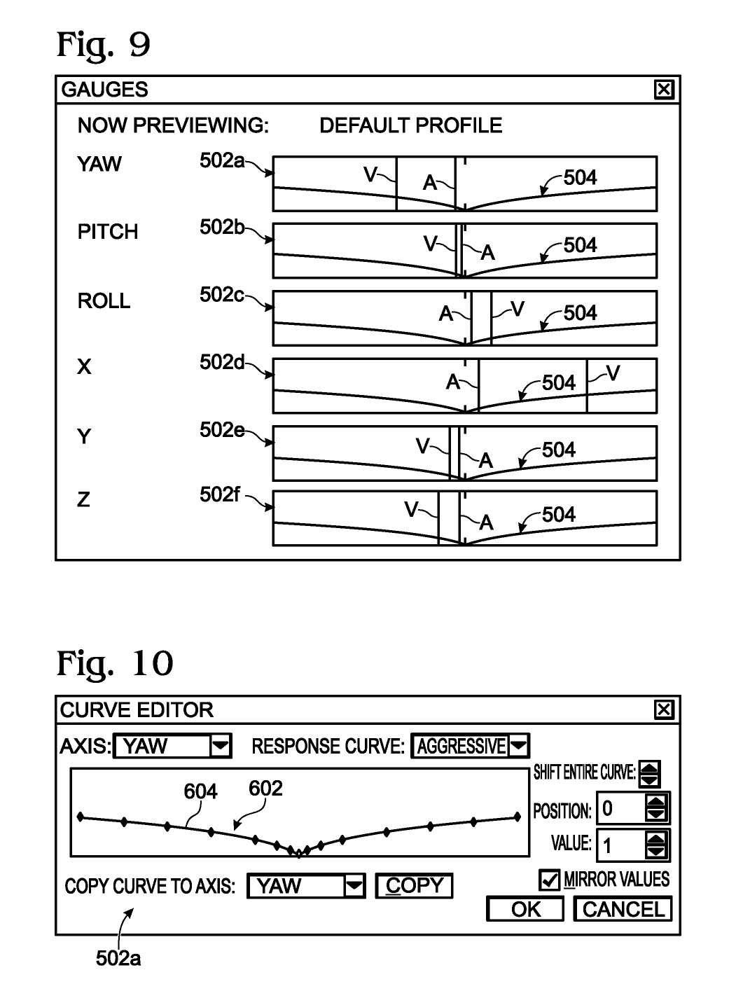

FIG. 9 provides a more detailed example showing actual and virtual indicators. Specifically, the figure shows a motion plot 502 for each of six degrees of freedom: yaw (FIG. 502a), pitch (FIG. 502b) and roll (FIG. 502c) rotation; and X (FIG. 502d), Y (FIG. 502e) and Z (FIG. 502f) translation. For each of the rotation plots, positive or relative rotation (about a centered position) is shown for both the actual position of the sensed object and the resultant virtual position. The actual rotational position (e.g., of the user's head) is shown with actual indicator A, while the virtual position is shown with virtual indicator V. Furthermore, each plot may include a profile characteristic 504 (for clarity, indicated only on plot 502a), indicating amplification (or some other characteristic of the corresponding virtual control) as a function of the position of the actual object along the movement axis. Similar to FIGS. 7A-7D and 8, the motion plots provide actual and virtual indicators allowing the user to readily ascertain the effects produced by movement of the sensed object.

In addition to or instead of demonstrating the relationship between actual movement and the corresponding control, the actual and virtual indicators may be used to facilitate adjustment of the applied control.

Referring first to FIGS. 7A-7D, the systems and methods described herein may be configured to enable the user to manipulate the depictions of the figures in order to vary/adjust the relationship between the physical motion and resulting control. For example, the software may be placed into an adjustment or configuration mode, in which the user can manipulate the position(s) of actual head 304 and/or virtual head 306 to vary the run-time correlation between the two. More specifically, the user might rotate virtual head into the 180° position (FIG. 7D), and then move the actual head into a desired position. Then, for example, if the user wanted to rotate the virtual scene by 180° by turning their head 10°, they would turn actual head by 10°. Similar user manipulation may be performed with the actual and virtual indicators of FIGS. 8 and 9.

The exemplary systems and methods described herein may also be adapted to enable resetting or calibration of the control produced by the position and positional changes of the sensed object. For example, in head sensing embodiments, it may be desirable to enable the user to set or adjust the neutral position or frame of reference (e.g., the origin or reference position from which translational and rotational movements are measured). For example, through another input device (such as a mouse or button on a game controller), the user may activate a calibration feature (e.g., incorporated into user interface and/or engine 40) so that the actual frame of reference is mapped to the virtual frame of reference, based on the position of the user's head at that instant. This resetting function may be activated at startup, from time to time during operation of the system, etc. As indicated above, the function may be activated at any time via a user-actuated input. In another embodiment, a zero point may be established automatically. A combination of automatic and user-selected calibration may also be employed, for example through use of default setpoint that is automatically selected if the user does not modify the setpoint within a specified time.

The particular zero point for the sensed object (e.g., the user's head) is thus adjustable via the resetting/calibration function. One user, for example, might prefer to be closer to the display monitor than another, or might prefer that relative movements be measured from a starting head position that is tilted forward slightly (i.e., pitch rotation). This is but one of many potential examples.

Referring now to FIG. 10, a more detailed view of motion plot 502a is depicted for yaw rotation. Motion plot 502a may be provide with various features enabling the user to adjust/vary the relationship between physical movement (i.e., yaw motion of the user's head or other sensed object) and control of the computer. As in the previous examples, manual manipulation of the actual and virtual indicators may be employed to adjust the control behavior. Alternatively, a characteristic profile may be created by the user, or the user may select from one or more pre-existing profiles. The following is a list of exemplary profiles:

Virtual Yaw Rotation (VYR)=α·Actual Yaw Rotation (AYR), where α is a constant;

VYR=(α•AYR)+β, where α and β are constants;

VYR=a•AYRn, where α and n are constants;

Any of examples, 1, 2 or 3, but with one or more dead spot regions;

Any of examples, 1, 2, 3 or 4, but with further control effects that vary with position, velocity and/or acceleration of the sensed object; etc.

It should be understood that the above list is exemplary only, and that an almost limitless number of possibilities may be employed. Furthermore, a changeable template characteristic may be displayed, allowing the user to manipulate the characteristic with a mouse or through some other input mechanism. For example, a template characteristic may, as with exemplary characteristic 602, have a plurality of reference points 604 that may be manipulated or adjusted by the user in order to produce desired changes to the control profile. Furthermore, a pulldown menu or other method of enabling the user to choose from a plurality of stored profiles, such as “aggressive, linear, etc.”, may be provided.

Referring now to FIGS. 7A-7D, it may be desirable that the control effects produced by a given movement or position of the sensed object be varied in response to certain conditions. As a first example, in a six-degrees-of-freedom system, it may be desirable to vary the translational frame of reference (i.e., the orientation of the X, Y and Z axes) in response to changes in rotational position of the sensed object. This example may be illustrated in the context of the flight simulator examples discussed with reference to FIGS. 7A-7D.

In the present example, a translational movement is correlated with a virtual movement according to a translational frame of reference. In other words, a rectilinear frame of reference is used so that actual movement in direction A1 produces a virtual movement in direction V1, actual movement in direction A2 produces virtual movement in direction V2, and so on. The initial translation frame of reference is indicated on the left side of FIG. 7A and is as follows: (1) X axis: horizontal translational movements of actual head 304 left to right in a plane that is parallel to the plane of display 308; (2) Y axis: vertical translational movements of actual head 304 up and down in a plane that is parallel to the plane of display 308 (the Y-axis is not visible in the frame of reference legend due to the depiction being a top view); and (3) Z axis: movements in and out relative to display 308 in a direction orthogonal to the plane of display 308. In FIG. 7B, the virtual frame of reference is similar, but in relation to instrument panel 320. Thus when the user moves their head closer to display 308, the displayed view of instrument panel 320 and out through windshield 314 is zoomed or magnified. When the user moves their head left to right (X axis) or up and down (Y axis), the view of the instrument panel and windshield displayed on display 308 pans accordingly.

Assume now, as in FIG. 7C, that the user has turned their head to the left by 12 degrees, and that the virtual movement is amplified so as to provide a virtual view out through the left side cockpit window 316. Thus, at this point, the scene displayed on monitor 308 is a view out through the left side window. Assume now that the user wished to get a closer view out through the window, or a closer view at an instrument or other thing disposed on the left side of cockpit 312. If the translational frame of reference remains the same as prior to the rotation, the user would have to move their head from right to left (X axis translation using the original frame of reference) to get a closer displayed view of the left side of the cockpit. In some settings, this may be undesirable or counterintuitive. Accordingly, the system may be configured so that the translational frame of reference varies with rotational position of the sensed object and/or rotational position/orientation of the virtual reality scene depicted on display 308. According to one example, the translation frame of reference is continuously and dynamically varied so that whenever the user moves their actual head closer to display 308, the resulting virtual translation causes the specific scene displayed on display 308 to be zoomed or enlarged. It should be understood, however, that frames of reference for both rotational and translational motion may be varied in many different ways in response to various types of motion for the sensed object and/or the virtual depicted scene.

As mentioned above, a profile including one or more scaling curves (e.g., motion plot 502 of the profile described in FIG. 9) may be created and/or manipulated in order to define a correlation between the actual, sensed movement (e.g., via sensed locations 34) and control that is effected (e.g., via control signals 44) on software/hardware 46. Profiles may include any suitable additional information (e.g., sensing apparatus 32 settings, hotkeys, etc.) that enables a user to configure use of a motion-based control system (e.g., system 30). In some embodiments, a single profile may be used by the system during most any or all use case scenarios. In other embodiments, profiles may be defined on a per-user basis, a per-object basis, a per-application basis, or according to any other suitable granularity.

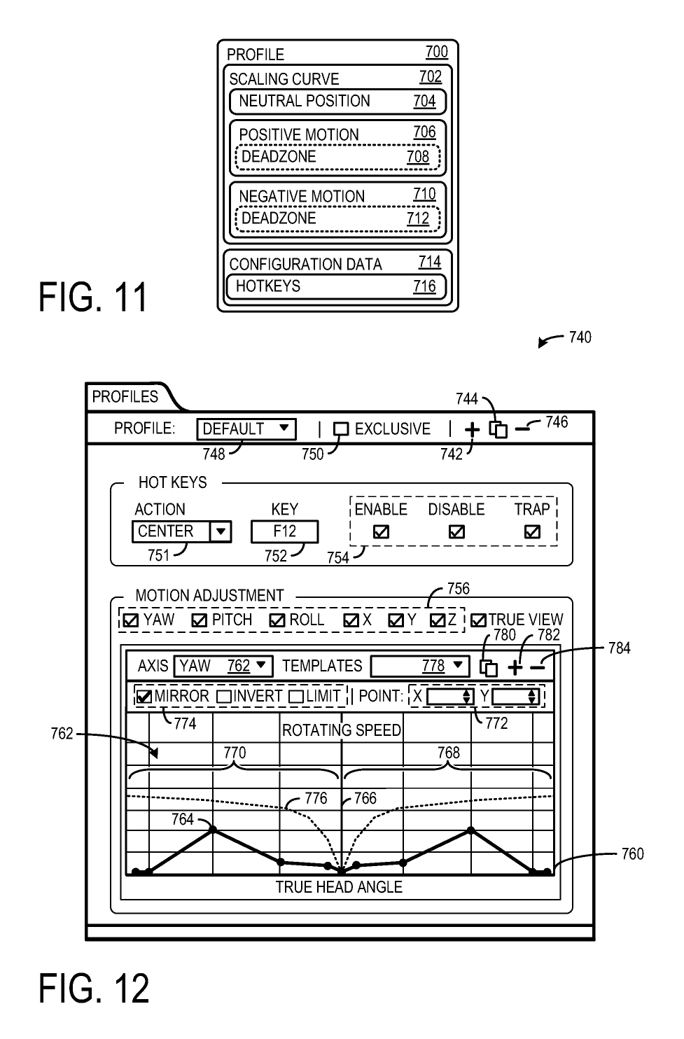

FIG. 11 shows an example embodiment of a profile 700. The profile 700 may take various forms in different implementations without departing from the scope of the present disclosure. In one example, the profile 700 may be implemented as described above with reference to FIG. 9. In another example, the profile 700 may be implemented as described in further detail below with reference to FIG. 12. As mentioned, profile 700 may include one or more scaling curves 702, each defining a relationship between a determined position relative to a virtual position in a rendered scene within an application program (e.g., flight simulator). For example, scaling curve 702 may represent the actual position of the sensed object versus a rate of change in virtual position or a derivative thereof.

In some embodiments, profile 700 may include six scaling curves 702 corresponding to six degrees of freedom (e.g., X, Y and Z axis translation, and rotation about the X, Y and Z axes). Each scaling curve 702 may represent a relationship between an actual position of the sensed object relative to a virtual position in that degree of freedom. For example, each scaling curve may define a range of actual positions relative to a range of changes in virtual position in that degree of freedom. As described above, it will be appreciated that a wide variety of correlations (e.g., scaled, linearly or non-linearly amplified, position-dependent, velocity-dependent, acceleration-dependent, etc.) may be employed between the actual movement and the control that is effected over the computer, and such correlations may be modified by manipulating the scaling curve for that particular correlation.

Each scaling curve 702 may include a neutral position 704 of the sensed object, a first set of points that define scaling of positive motion 706 from the neutral position along the scaling curve, and a second set of points that define scaling of negative motion 710 from the neutral position along the scaling curve. In some embodiments, scaling curve 702 further includes one or more points 708 and 712 on the scaling curve that results in no change in virtual position relative to a change in the actual position of the sensed object that may be referred to as “dead zones.” Furthermore, dead zones may include a range of points on the scaling curve that results in no change in virtual position relative to a change in the actual position of the sensed object. In some embodiments, the first set of points on the scaling curve that define positive scaling may include one or more dead zones. In some embodiments, the second set of points on the scaling curve that define negative scaling may include one or more dead zones. Profile 700 may further include configuration data 714 including hotkey data 716, which will be discussed in greater detail below.

A motion control system (e.g., system 30) may be configured with one or more pre-defined profiles 700 (a.k.a., scaling profiles in some cases). For example, a default profile may be defined that provides a starting point for novice users of the motion control system. Such a default profile may be optimized for a broad range of software/hardware 46 (e.g., variety of genres and game play styles) via inclusion of a pronounced dead zone 708/712 about neutral position 704 such that minor, unintended movements of the sensed object (e.g., a user's head) do not result in unwanted movements of the rendered object. Other examples of pre-defined profiles include, but are not limited to, a “smooth” profile and a “one-to-one” profile. A smooth profile may include a smaller dead zone than the above-described default profile. In other words, the range of points on the scaling curve that results in no change in virtual position relative to a change in the actual position may be larger in the smooth profile than in the default profile. Further, the smooth profile may include a substantially constant scaling relationship along the scaling curve for both positive motion 706 and negative motion 710. In contrast, a one-to-one profile may include unity scaling of positive motion 706 and negative motion 710 and may lack dead zones. In other words, a one-to-one profile may result in direct (e.g., unsealed) translation of actual movement into virtual movement.

It will be appreciated that the pre-defined profiles described above are presented for the purpose of example, and are not intended to be limiting in any manner. In some embodiments, different and/or additional profiles may be provided with the system (e.g., via engine software 40). Further, in some embodiments, game designers and/or other entities associated with a given objective of control 46 may provide a pre-defined profile designed for the objective. In yet other embodiments, scaling profile may be created by a user and may be dynamically updated or modified by the user as desired.

Turning now to FIG. 12, an example embodiment of a graphical user interface 740 for providing manipulation of profiles (e.g., profile 700) is shown. Interface 740 may be provided, for example, via engine software 40. Interface 740 includes user-actuatable elements 742, 744, 746 configured to allow a user of interface 740 to add, copy, and delete profiles, respectively. In some embodiments, actuating one or more elements 742, 744, and 746 (e.g., via mouse click, touch screen input, etc.) may result in the display of one or more confirmation mechanisms (e.g., dialog box, etc.) to verify the user input. Interface 740 further includes element 748 by which a user may select a particular predefined or saved profile from one or more profiles for manipulation via interface 740. In some embodiments, element 748 may be further configured to allow naming of the selected profile (e.g., when creating a new profile). In some embodiments, interface 740 may include element 750 that, when selected, locks the profile selected via element 748 as the global profile. In other words, a pre-determined set of software/hardware 46 (e.g., some or all motion controlled software/hardware) will be controlled (e.g., via control signals 44) according to the exclusively loaded profile selected via element 748. In some embodiments, automatic loading of other profiles is disabled upon selection of element 750.

As mentioned above, profiles may further include configuration data 714 including one or more hotkeys 716. Hotkeys 716 allow a user to map key presses, or other specified user input, to perform functions of engine software 40 and/or command interface 48. Such hotkeys may be usable within interface 740 and/or within different interfaces (e.g., from within a video game operating as an objective of control). Interface 740 may include action element 751 and key element 752 to define a hotkey input and an associated hotkey action, respectively. In some embodiments, hotkeys may be definable on a per-profile basis and/or a per-application basis.

Hotkey actions selectable via action element 750 may include, for example, a “pause” action, a “center” action, and a “precision” action. A pause action, when activated, may temporarily pause the provision of the control signals 44 to software/hardware 46 (e.g., video game). A “center” action may be configured to re-calibrate the neutral position (e.g., neutral position 704) of the sensed object. Actuation of such an element may activate a calibration feature so that the actual frame of reference is mapped to the virtual frame of reference, based on the position of the sensed object (e.g., user's head) at that instant. One user, for example, might prefer to be closer to the display monitor than another, or might prefer that relative movements be measured from a starting head position that is tilted forward slightly (i.e., pitch rotation). The precision action may be configured to enable “smooth” scaling. For example, activation of a “precision” hotkey may result in the “smooth” profile to be temporarily loaded in place of the current profile. As another example, the precision action may be configured to modify the scaling curve (e.g., scaling curve 702). In particular, by loading the smooth scaling profile or modifying the scaling curve, the relationship between actual movement and virtual movement (e.g., decreasing a scaling gain on one or more scaling curves) may be modified. In this manner, precision movements may be made more easily by a user. It will be understood that these scenarios are presented for the purpose of example, and that different and/or additional hotkey actions may be provided without departing from the scope of the present disclosure. For example, in some embodiments, users may be able to define custom hotkey actions.

Interface 740 may further include hotkey elements 754 configured to, for example, turn a hotkey on, turn a hotkey off, and “trap” a hotkey. Trapping a hotkey may result in the hotkey being exclusive to engine software 40 such that it may not be recognized by other applications or may only be recognized when engine software 40 is being executed. Such an option may be desirable to prevent key presses from other applications interfering with the software engine, and/or vice versa. In some embodiments, interface 740 may include additional and/or different hotkey elements 754. For example, interface 740 may include a “toggle” element configured to define a mechanism by which the hotkey may be disabled and enabled. A particular user input (e.g., key press) may be performed to alternately enable and disable a “toggled” hotkey. In contrast, a hotkey that is not “toggled” may be enabled only during concurrent performance of a user input (e.g., key press), and otherwise disabled.

Interface 740 may further include degree of freedom (DOF) elements 756. DOF elements 756 may be configured to alternately disable and enable motion tracking along a particular DOF. For example, as illustrated, deselecting the “X” element may disable motion tracking along the x-axis (e.g., horizontal direction). While 6 DOF are illustrated, it will be understood that interface 740 may include additional and/or different DOF elements 756 without departing from the scope of the present disclosure.

Interface 740 further includes a two-dimensional representation 760 of the scaling curve (e.g., scaling curve 702) for a given DOF (e.g., yaw) selected via element 762 (e.g., drop-down menu). Representation 760 may be provided with various features enabling the user to adjust/vary the relationship between physical movement (i.e., yaw motion of the user's head or other sensed object) and control of the computer (e.g., control of software/hardware 46) defined by the scaling curve (e.g., scaling curve 702). For example, in some embodiments, one or more selectable points 764 along representation 760 may be manipulated (e.g., dragged) in one or two dimensions in order to effect a corresponding change in the scaling curve. Representation 760 includes a neutral position 766 of the sensed object and a first set of points 768 defining scaling of positive motion from neutral position 766 along the scaling curve and a second set of points 770 defining scaling of negative motion from neutral position 766 along the scaling curve.

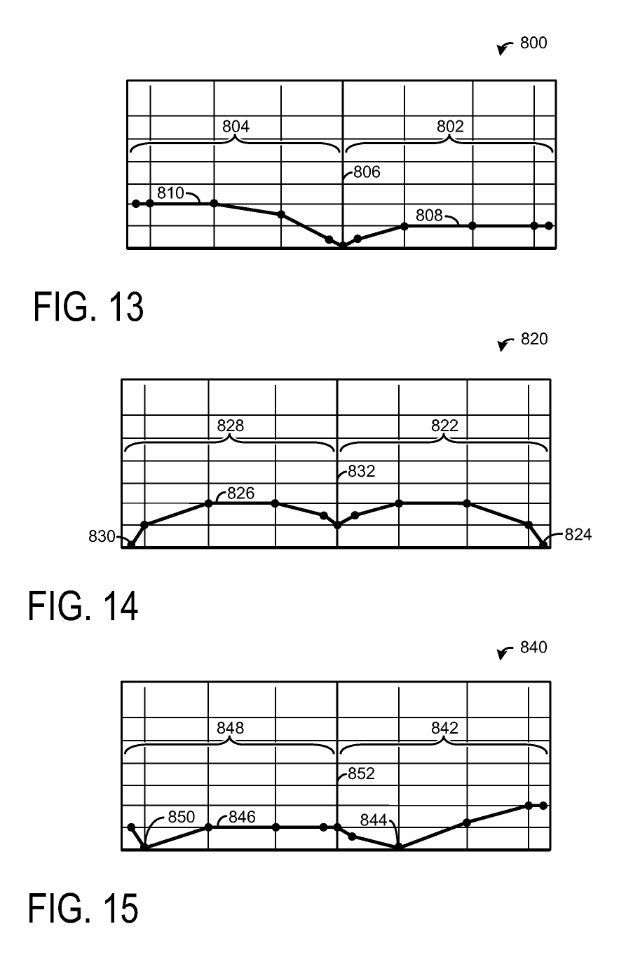

As illustrated, first set of points 768 matches second set of points 770 relative to neutral position 766 such that scaling of positive motion minors scaling of negative motion. However, it will be understood that the scaling curve, and thus representation 760 thereof, may include any suitable configuration. FIGS. 13-15 show other example embodiments of representations (e.g., 760) of scaling curves.

FIG. 13 shows a first example representation 800 where first set of points 802 differs from second set of points 804 relative to the neutral position 806 such that scaling 808 of positive motion differs from scaling 810 of negative motion. More particularly, the scaling of negative motion generally may be greater than the scaling of positive motion in this example.

FIG. 14 shows a second example representation 820 where first set of points 822 includes first point 824 on scaling curve 826 that results in no change in virtual position relative to a change in the actual position of the sensed object (i.e., dead zone), and second set of points 828 includes second point 830 on scaling curve 826 that results in no change in virtual position relative to a change in the actual position of the sensed object. As illustrated, first point 824 and second point 840 are located a same distance from neutral position 832 on scaling curve 826. Moreover, the positive scaling and the negative scaling are minor images

FIG. 15 shows a third example representation 840. Representation 840 is similar to representation 820 in that representation 840 includes first set of points 842 including first point 844 on scaling curve 846 that results in no change in virtual position relative to a change in the actual position of the sensed object (i.e., dead zone), and second set of points 848 including second point 850 on scaling curve 846 that results in no change in virtual position relative to a change in the actual position of the sensed object. However, first point 844 is located a different distance from neutral position 852 than second point 850 on scaling curve 846. Note that, in some cases, the individual dead zone points may be expanded to include a range of dead zone points without departing from the scope of the present disclosure. It will be understood that FIGS. 13-15 are presented for the purpose of example, and that scaling curves may include any suitable shape and may be presented via any suitable representation without departing from the scope of the present disclosure.

Returning to FIG. 12, greater control maybe provided via tuning elements 772. Tuning elements 772 may allow for manual entry of coordinates (e.g., via text box, etc.) for a given reference point 764 on the scaling curve. Tuning elements 772 may further include one or more elements (e.g., arrows) configured to provide highly granular (e.g., single unit step) adjustment of the coordinates. In other embodiments, representation 760 may be adjustable via elements other than reference points 764. For example, in touch screen scenarios, a user may be able to “draw” a desired representation 760 of the scaling curve.

Representation 760 may be zoomed, for example, by hovering over representation 760 with a mouse pointer and using the scroll wheel to move in and out. As another example, representation 760 may be zoomed by left-clicking and dragging over a region. It will be understood that these scenarios are presented for the purpose of example, and that representation 760 may be adjustable via any suitable mechanism or combination of mechanism without departing from the scope of the present disclosure.

Interface 740 may further include curve elements 774 configured to further manipulate representation 760. For example, curve elements 774 may include an element (e.g., “minor”) configured to activating a mirror function that matches first set of points 768 and second set of points 770 relative to neutral position 766 such that scaling of positive motion minors scaling of negative motion. For example, upward manipulation of the leftmost point of representation 760 may result in corresponding upward adjustment of the rightmost point. Similarly, leftward manipulation of points 768 may result in corresponding rightward (i.e., horizontally mirrored) manipulation of points 770. When deselected, a user may be able to manipulate points 764 such that first set of points 768 differs from second set of points 770 relative to neutral position 766 such that scaling of positive motion differs from scaling of negative motion.

Curve elements 774 may further include an element (e.g., “invert”) configured to reverse first set of points 768 and second set of points 770, thereby inverting tracking along the selected DOF(e.g., leftward actual movement corresponds to rightward virtual movement). Such a feature may be desirable in inverted-controls scenarios (e.g., flight simulators) and may further allow re-orientation of the position sensing camera without requiring extensive modification to the user profile (e.g., profile 700). For example, one or more profiles may be defined when the position sensing camera is located in front of the sensed object (e.g., the user's head). Upon relocating the position sensing camera behind the sensed object, selection of the “invert” element may result in the same control effected between actual movement and virtual movement as before the relocation of the position sensing camera. Curve elements 774 may further include an element (e.g., “limit”) configured to, when selected, limit movement along rotational axes (e.g., yaw, pitch roll) to 180 degrees. In other words, rotation of the sensed object greater than 90 degrees from neutral position 766 may be ignored (e.g., control signals 44 not provided).

In some embodiments, interface 740 may be configured (e.g., via elements 774) to effect a global change applied to each scaling curve (e.g., scaling curve 702 for each DOF) associated with the profile selected via element 748. For example, activation of an “invert” element may invert tracking for each scaling curve associated with the profile, and not just the scaling curve depicted via representation 760.

Representations 760 may be managed similarly to the profiles themselves. For example, a given representation 760 may be saved, and subsequently displayed, as template 776 for use in defining one or more other scaling curves in the same profile and/or in different profiles. Accordingly, interface 740 may further include elements 778, 780, 782, and 784 configured to select, copy, add, and delete a given template, respectively. While illustrated as a dashed line, it will be understood that template 776 may include any suitable configuration. For example, in some embodiments, upon selection of a given template 776 via element 778 (e.g., drop-down menu), representation 760 may be configured to adjust as to minor the shape of template 776. In some embodiments, template 776 may include configuration 714 of profile 700. In other embodiments, template 776 may be stored by engine software 40 as part of a software-specific configuration.

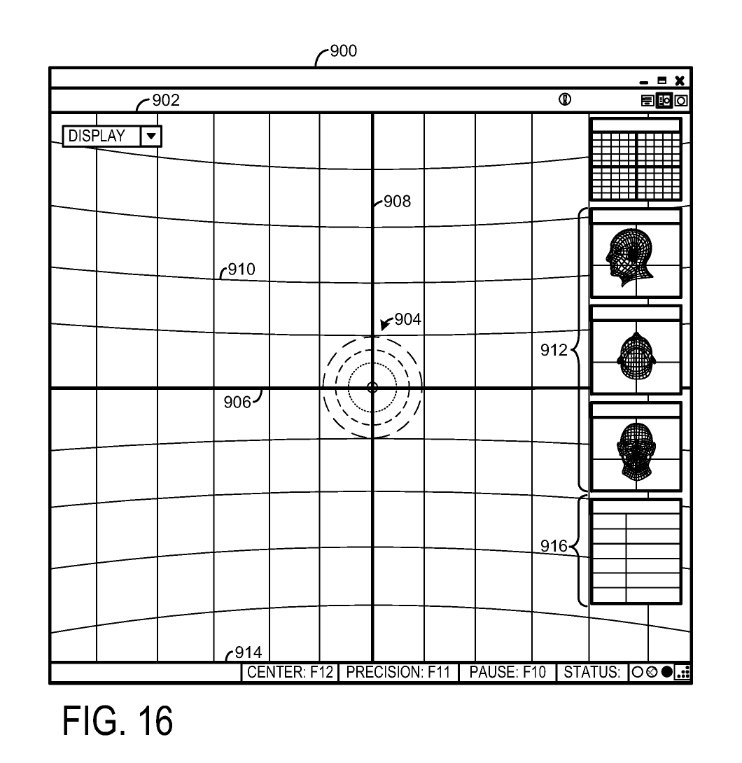

Turning now to FIG. 16, an example embodiment of a graphical user interface 900 including a first-person virtual world viewing window 902 is shown. The first-person view may correspond to a virtual position in a rendered scene that is controlled based on actual movement of the sensed object. For example, window 902 may be usable concurrently with interface 740 in order to fine-tune behavior of a user profile (e.g., profile 700). Accordingly, window 902 may be displayed (e.g., on monitor 103) via engine software 40 and/or command interface 48) simultaneously with interface 740. Window 902 may be configured to display a change in a virtual position within a rendered scene including axes 906 and 908 and grid 910. In some embodiments, the rendered scene may include a graphical overlay (e.g., representation of aircraft cockpit) instead of, or in addition to, axes 906 and 908 and grid 910. Such an overlay may enable a user to better comprehend the performance of a given profile for a given objective of control (e.g., flight simulator). In some embodiments, the overlay may be user-definable (e.g., via selection of an image file and/or via image capture).

The virtual position may be displayed via indicator 904 including, for example, a bulls-eye or other suitable configuration (e.g., reticule). Accordingly, as the determined position of the sensed object (e.g., orientation of a user's head) changes, indicator 904 may be configured to move about grid 910 according to the relationship between the actual position and the virtual position defined by a given profile. For example, leftward motion of the sensed object (e.g., the users' head) may result in corresponding leftward motion of indicator 804 along axis 906 according to the scaling profile. In some embodiments, axes 906 and 908 may include indicators (e.g., tick marks) of scale.

Interface 900 may further include one or more third-person views 912 each providing a third-person view of the virtual position. For example, as illustrated, views 912 may include wire-frame models of a human head representing the virtual position determined based on a sensed position of the user's head. Accordingly, when a user looks downward, the side-view may display a corresponding counter-clockwise (downward) rotation of the virtual head according to the scaling properties of the selected profile. Views 912 may provide another feedback mechanism for comprehending, and therefore adjusting, a given user profile. While discussion is directed towards motion of user's head, and thus display of head-shaped representations in views 912, it will be understood that views 912 may include any suitable configuration (e.g., full-body wireframe models).

Interface 900 may further include status bar 914 and configuration data 916. Status bar 914 may display, for example, current hotkey settings (e.g., hotkey data 716 of profile 700). Configuration data 916 may represent the data (e.g., position signals 42) received from the position sensing camera. Such information may be useful in debugging various issues with the motion control system.

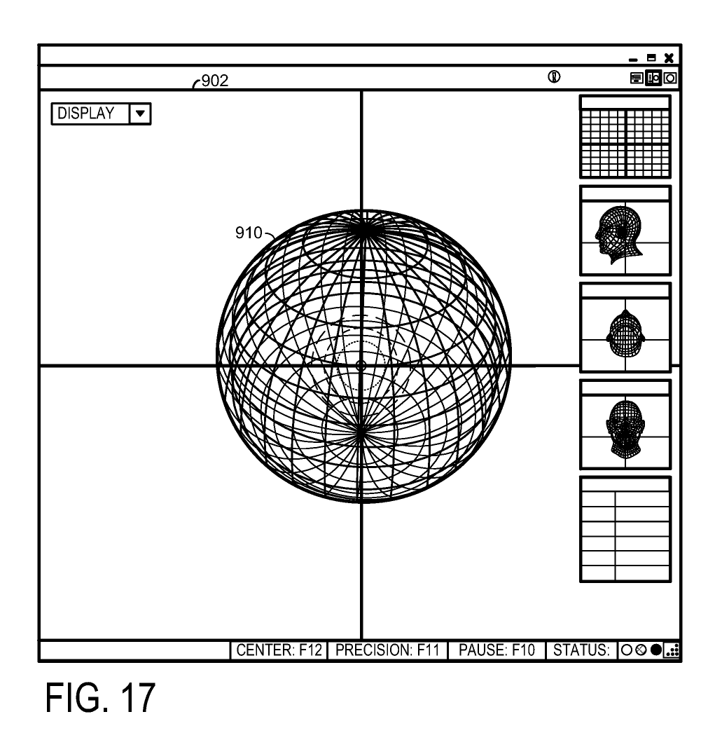

FIG. 17 shows another example view provided by first-person virtual world viewing window 902 of FIG. 16. In contrast to FIG. 16, window 902 is substantially zoomed out such that grid 910 is depicted as a sphere. The sphere may represent a three dimensional virtual world that may provide additional visual feedback for tuning a profile relative to a different shaped space (e.g., a rectangular space).

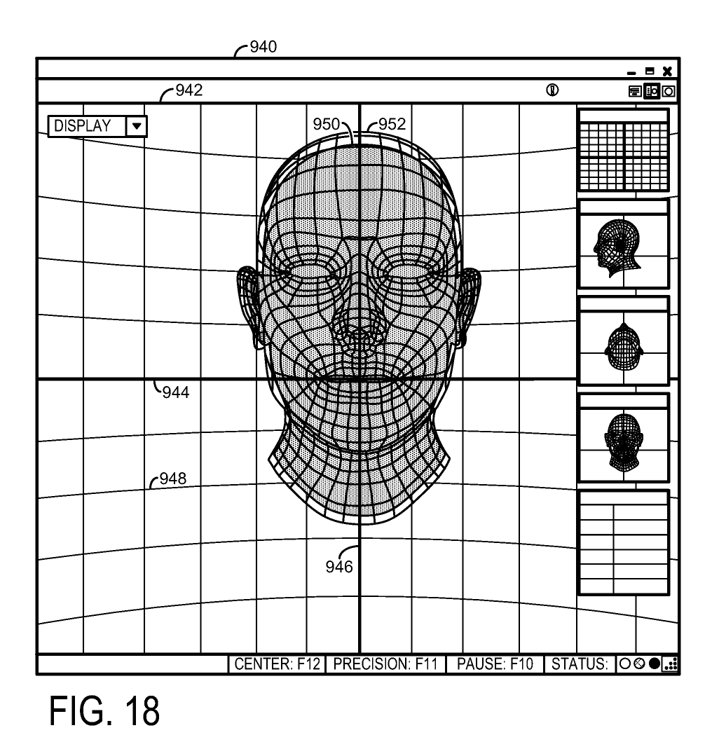

Turning now to FIG. 18, an example embodiment of a graphical user interface 940 including a third-person virtual world viewing window 942 is shown. Similar to the first-person view of window 802, window 942 may include axes 944 and 946 and grid 948. However, instead of indicator 804, window 942 may include actual representation 950 and virtual representation 952. For example, as illustrated, representations 950 and 952 may include a rendered head model and a wire-frame head model, respectively. Accordingly, as a user moves their head, the detected movement is displayed via actual representation 950 and the corresponding virtual movement is displayed via virtual representation 952. For example, when utilizing a profile with greater-than-unity scaling, the motion of actual representation 952 may be less than the corresponding motion of virtual indicator 950. As with window 802, such a configuration may allow a user to better comprehend the performance of a given profile. Further, representations 950 and 952 may be repositionable (e.g., to provide views similar to views 812) in up to 6DOF. It will be understood that these representations are presented for the purpose of example, and that representations 950 and 952 may include any suitable configuration.

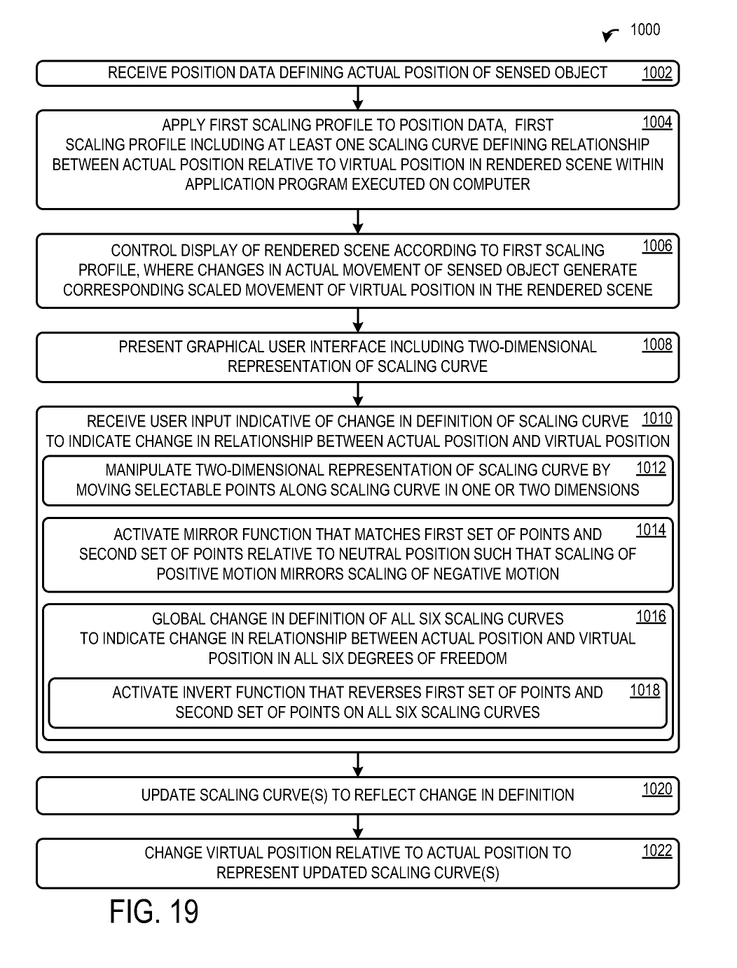

Turning now to FIG. 19, a process flow depicting an embodiment of a method 1000 for controlling a computer (e.g., software/hardware 46) is shown. Method 1000 includes, at 1002, receiving position data (e.g., position data 42) defining an actual position of a sensed object (e.g., locations 34). The position data may be received, for example, from a camera (e.g., sensing apparatus 32). At 1004, method 1000 includes applying a first scaling profile (e.g., profile 700) to the position data, the first scaling profile including at least one scaling curve (e.g., scaling curve 702) defining a relationship between the actual position relative to a virtual position in a rendered scene within an application program executed on the computer. As described above, in some embodiments, a profile may include more than one scaling curve. For example, the scaling profile may include, six scaling curves corresponding to six degrees of freedom, each scaling curve representing a relationship between an actual position of the sensed object relative to a virtual position in that degree of freedom, where the scaling curve defines a range of actual positions relative to a range of changes in virtual position in that degree of freedom.

In some embodiments, each scaling curve may define a range of actual positions of the sensed object relative to a range of changes in virtual position. As described above, scaling curves may include a wide variety of correlations (e.g., scaled, linearly or non-linearly amplified, position-dependent, velocity-dependent, acceleration-dependent, etc.) between the actual movement and the control that is effected over the computer. In some embodiments, a scaling curve may represent the actual position of the sensed object versus a rate of change in virtual position or a derivative thereof.

Regardless of the correlation defined by a given scaling curve, each scaling curve may include a neutral position of the sensed object (e.g., neutral position 704). Each scaling curve may further include a first set of points defines scaling of positive motion (e.g., positive scaling 706) from the neutral position along the scaling curve at 1014, and a second set of points defines scaling of negative motion (e.g., scaling 710) from the neutral position along the scaling curve.

Method 1000 further includes, at 1006, controlling display of the rendered scene (e.g., via sensed locations 34 corresponding to the sensed object) according to the first scaling profile, where changes in actual movement of the sensed object generate corresponding scaled movement of the virtual position in the rendered scene. For example, as described above, engine software 40 and/or command interface 48 may provide control signals 44 to software/hardware 46 based on position signals 42 and the scaling profile (e.g., profile 700). At 1008, method 1000 further includes presenting a graphical user interface (GUI) (e.g., interface 740) including two-dimensional representation of the scaling curve (e.g., representation 760). As mentioned above in reference to interface 740, representations other than representation 760 may be provided. For example, in some embodiments, the representation may include a three-dimensional representation.

At 1010, method 1000 includes receiving user input (e.g., via interface 740) indicative of a change in a definition of the scaling curve to indicate a change in relationship between the actual position and the virtual position. For example, user input may include, at 1012, manipulating the two-dimensional representation of the scaling curve by moving selectable points (e.g., points 764) along the scaling curve in one or two dimensions. As another example, user input may include, at 1014, activating a minor function (e.g., via one of elements 774) that matches the first set of points (e.g., points 770) and the second set of points (e.g., points 768) relative to the neutral position (e.g., neutral position 766) such that scaling of positive motion minors scaling of negative motion.

In some cases, user input may include a change to more than one scaling cure. For example, at 1016, method 1000 may include receiving user input indicative of a global change in a definition of all six scaling curves to indicate a change in relationship between the actual position and the virtual position in all six degrees of freedom. As mentioned above in reference to interface 740, the user interface may be configured (e.g., via elements 774) to effect a global change applied to each scaling curve (e.g., scaling curve 702 for each DOF) associated with the profile selected via element 748. For example, a global change may include, at 1018, activating an invert function that reverses the first set of points and the second set of points on all of the six scaling curves of the profile.

Method 1000 further includes, at 1020, updating the scaling curve to reflect the change in the definition. At 1022, method 1000 further includes changing the virtual position relative to the actual position to represent the updated scaling curve. In global change scenarios, updating at 1000 may include updating the six scaling curves to reflect the global change in the definition. Similarly, changing the virtual position at 1022 may include changing the virtual position relative to the actual position to represent the six updated scaling curves.

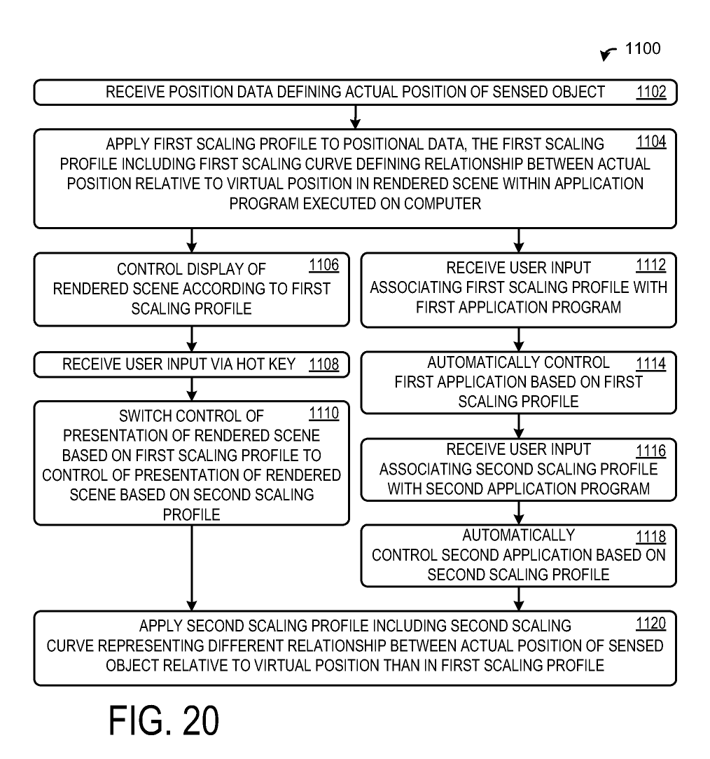

Turning now to FIG. 20, a process flow depicting an embodiment of a method 1100 for controlling a computer (e.g., software/hardware 46) utilizing multiple scaling profiles (e.g., profile 700) is shown. At 1102, method 1100 includes receiving position data (e.g., position data 42) defining an actual position of a sensed object (e.g., sensed locations 34). At 1104, method 1100 includes applying a first scaling profile (e.g., profile 700) to the positional data, the first scaling profile including a first scaling curve (e.g., scaling curve 702) defining a relationship between the actual position relative to a virtual position in a rendered scene within an application program (e.g., software/hardware 46) executed on the computer. In some embodiments, the first scaling curve may represent the actual position of the sensed object versus a first rate of change in virtual position. As mentioned above, the scaling curve may include different and/or additional relationships without departing from the scope of the present disclosure. The first scaling curve may further include a first point on the first scaling curve that results in no change in virtual position relative to a change in the actual position of the sensed object (i.e., a dead zone). As mentioned above, the scaling profile may include any number and configuration of dead zones without departing from the scope of the present disclosure.

As mentioned above, profiles (e.g., profile 700) may be defined on a per-user basis, a per-object basis, a per-application basis, or according to any other suitable granularity. Accordingly, one or more profiles may be associated with a given software/hardware object 46. A user may therefore be able to alternately utilize each of the scaling profiles for control of the given software/hardware object 46. Similarly, a user may be able to associate different scaling profiles with different objects 46. For example, a user may associate one scaling profile with a flight simulator while associating another scaling profile with a racing game. In other words, any suitable combination of scaling profiles may be associated with any suitable combination of objects.

At 1106, method 1100 includes controlling display of the rendered scene according to the first scaling profile, where changes in actual movement of the sensed object generate corresponding scaled movement of the virtual position in the rendered scene according to the first scaling curve. In other words, virtual motion (e.g., within a flight simulator game) may be controlled based on the position data and the first scaling profile. At 1108, method 1100 may include receiving user input via a hotkey (e.g., hotkey defined by hotkey data 716), and may further include, in response to receiving the user input via the hotkey, switching control of presentation of the rendered scene based on the first scaling profile to control of presentation of the rendered scene based on the second scaling profile at 1110. For example, actual movement of the sensed object may be scaled based on the scaling curves of the second profile instead of the scaling curves of the first profile to produced virtual motion that is scaled differently.

In some embodiments (e.g., multiple-software/hardware object scenarios), at 1112, method 1100 includes receiving user input associating the first scaling profile with a first application program, and, at 1114, automatically controlling the first application based on the first scaling profile. For example, scaling curves of the first profile may be applied to the actual movement of the sensed object to produce scaled virtual movement in the first application based on the first profile. Such user input may be received, for example, via user interface 740. Method 1100 may include receiving user input associating the second scaling profile with a second application program at 1116, and may further include automatically controlling the second application based on the second scaling profile at 1118. For example, scaling curves of the second profile may be applied to the actual movement of the sensed object to produce scaled virtual movement in the second application based on the second profile.

Regardless of software/hardware object 46 associated with the second profile (e.g., same object or different object than the first profile), method 1100 continues from 1110 or 1118 to 1120. At 1120, method 11000 includes applying a second scaling profile including a second scaling curve representing a different relationship between the actual position of the sensed object relative to the virtual position than in the first scaling profile. Similar to the first scaling curve, the second scaling curve may represent the actual position of the sensed object versus a second rate of change in virtual position that differs from the first rate of change of the firs scaling profile. Accordingly, in single software application scenarios, applying the second profile may result in controlling display of the rendered scene according to the second scaling profile, where changes in actual movement of the sensed object generate corresponding scaled movement of the virtual position in the rendered scene according to the second scaling curve.

In some embodiments, the second scaling curve may include a second point on the second scaling curve that results in no change in virtual position relative to a change in the actual position of the sensed object (i.e., dead zone), and the second point may be positioned at a different location on the second scaling curve than a location of the first point on the first scaling curve. For example, the first scaling curve may have a small dead zone centered about the neutral position and the second scaling curve may have a dead zone centered about the neutral position that is larger than the small dead zone of the first scaling curve. As another example, a first scaling curve may have a dead zone that is proximate to the neutral position and the second scaling curve may have a dead zone that is proximate to an outer limit of the range of positive motion of the second scaling curve (e.g., ninety degrees of actual rotation).

In some embodiments, the second scaling curve may represent the actual position of the sensed object versus a second rate of change in virtual position that is greater than the first rate of change of the first scaling curve. Further, the first scaling curve may include a first range of points that results in no change in virtual position relative to a change in the actual position of the sensed object and the second scaling curve may include a second range of points that results in no change in virtual position relative to a change in the actual position of the sensed object that is smaller than the first range. For example, such a change in control may be achieved by switching between the above-mentioned default profile and the smooth profile.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various intake configurations and method implementations, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method from controlling a computer, comprising:
receiving position data defining an actual position of a sensed object;
applying a first scaling profile to the position data, the first scaling profile including at least one scaling curve defining a relationship between the actual position relative to a virtual position in a rendered scene within an application program executed on the computer, where the scaling curve defines a range of actual positions of the sensed object relative to a range of changes in virtual position, where the scaling curve includes a neutral position of the sensed object and a first set of points defines scaling of positive motion from the neutral position along the scaling curve and a second set of points defines scaling of negative motion from the neutral position along the scaling curve; and
controlling display of the rendered scene according to the first scaling profile, where changes in actual movement of the sensed object generate corresponding scaled movement of the virtual position in the rendered scene.

2. The method of claim 1, further comprising:
receiving user input indicative of a change in a definition of the scaling curve to indicate a change in relationship between the actual position and the virtual position;
updating the scaling curve to reflect the change in the definition; and
changing the virtual position relative to the actual position to represent the updated scaling curve.

3. The method of claim 2, further comprising:
presenting a graphical user interface (GUI) including a two-dimensional representation of the scaling curve, and receiving user input includes manipulating the two-dimensional representation of the scaling curve by moving selectable points along the scaling curve in one or two dimensions.

4. The method of claim 2, where receiving user input includes activating a mirror function that matches the first set of points and the second set of points relative to the neutral position such that scaling of positive motion minors scaling of negative motion.

5. The method of claim 1, where the scaling profile includes six scaling curves corresponding to six degrees of freedom, each scaling curve representing a relationship between an actual position of the sensed object relative to a virtual position in that degree of freedom, where the scaling curve defines a range of actual positions relative to a range of changes in virtual position in that degree of freedom.

6. The method of claim 5, further comprising:
receiving user input indicative of a global change in a definition of all six scaling curves to indicate a change in relationship between the actual position and the virtual position in all six degrees of freedom;
updating the six scaling curves to reflect the global change in the definition; and
changing the virtual position relative to the actual position to represent the six updated scaling curves.

7. The method of claim 6, where the global change includes activating an invert function that reverses the first set of points and the second set of points on all of the six scaling curves.

8. The method of claim 1, where the scaling curve represents the actual position of the sensed object versus a rate of change in virtual position or a derivative thereof.

9. A system for controlling operation of a computer, comprising:
a position sensing camera configured to sense an actual position of a sensed object and produce positional data that corresponds to multiple potential positions of the sensed object;
engine software, operatively coupled with the position sensing camera, configured to (1) select a determined actual position of the sensed object from among the multiple potential positions of the sensed object based on the positional data from the position sensing camera, (2) apply a first scaling profile to the positional data corresponding to the actual position, the first scaling profile including at least one scaling curve defining a defining a relationship between the actual position relative to a virtual position in a rendered scene within an application program executed on the computer, where the scaling curve defines a range of actual positions of the sensed object relative to a range of changes in virtual positions in the rendered scene, where the scaling curve includes a neutral position of the sensed object and a first set of points that define scaling of positive motion from the neutral position along the scaling curve and a second set of points that define scaling of negative motion from the neutral position along the scaling curve, and at least one point on the scaling curve results in no change in virtual position relative to a change in the actual position of the sensed object, and (3) control display of the rendered scene according to the first scaling profile, where changes in actual movement of the sensed object generate corresponding scaled movement of the virtual position in the rendered scene.

10. The system of claim 9, where the first set of points differs from the second set of points relative to the neutral position such that scaling of positive motion differs from scaling of negative motion.

11. The system of claim 9, where the first set of points matches the second set of points relative to the neutral position such that scaling of positive motion mirrors scaling of negative motion.

12. The system of claim 9, where the first set of points includes a first point on the scaling curve that results in no change in virtual position relative to a change in the actual position of the sensed object, and the second set of points includes a second point on the scaling curve that results in no change in virtual position relative to a change in the actual position of the sensed object.

13. The system of claim 12, where the first point and the second point are located a same distance from the neutral position on the scaling curve.

14. The system of claim 12, where the first point and the second point are located a different distance from the neutral position on the scaling curve.

15. The system of claim 9, where the scaling profile includes six scaling curves corresponding to six degrees of freedom, each scaling curve representing a relationship between an actual position of the sensed object relative to a virtual position in that degree of freedom, where the scaling curve defines a range of actual positions relative to a range of changes in virtual position in that degree of freedom, and each scaling curve includes at least one point on the scaling curve that results in no change in virtual position relative to a change in the actual position of the sensed object.

16. The system of claim 9, where the scaling curve represents the actual position of the sensed object versus a rate of change in virtual position or a derivative thereof.

17. The system of claim 16, where the engine software is configured to apply a second scaling profile including at least one scaling curve representing a different relationship between the actual position of the sensed object relative to the virtual position and a different point that results in no change in virtual position relative to a change in the actual position of the sensed object than in the first scaling profile.

18. The system of claim 16, where the second scaling profile includes a scaling curve where the rate of change is greater than a rate of change of a corresponding scaling curve of the first scaling profile, and a range of points that results in no change in virtual position relative to a change in the actual position of the sensed object on the scaling curve of the second scaling profile is smaller than a corresponding range on the scaling curve of the first scaling profile.

19. A method for controlling a computer, comprising:
receiving position data defining an actual position of a sensed object;
applying a first scaling profile to the positional data, the first scaling profile including a first scaling curve defining a relationship between the actual position relative to a virtual position in a rendered scene within an application program executed on the computer, where the first scaling curve represents the actual position of the sensed object versus a first rate of change in virtual position, and where a first point on the first scaling curve results in no change in virtual position relative to a change in the actual position of the sensed object;
controlling display of the rendered scene according to the first scaling profile, where changes in actual movement of the sensed object generate corresponding scaled movement of the virtual position in the rendered scene according to the first scaling curve;
applying a second scaling profile including a second scaling curve representing a different relationship between the actual position of the sensed object relative to the virtual position than in the first scaling profile; and
controlling display of the rendered scene according to the second scaling profile, where changes in actual movement of the sensed object generate corresponding scaled movement of the virtual position in the rendered scene according to the second scaling curve.

20. The method of claim 19, where the second scaling curve represents the actual position of the sensed object versus a second rate of change in virtual position that differs from the first rate of change of the firs scaling profile.

21. The method of claim 19, where a second point on the second scaling curve results in no change in virtual position relative to a change in the actual position of the sensed object, and where the second point is positioned at a different location on the second scaling curve than a location of the first point on the first scaling curve

22. The method of claim 19, where the second scaling curve represents the actual position of the sensed object versus a second rate of change in virtual position that is greater than the first rate of change of the first scaling curve, where the first scaling curve includes a first range of points that result in no change in virtual position relative to a change in the actual position of the sensed object and the second scaling curve includes a second range of points that result in no change in virtual position relative to a change in the actual position of the sensed object that is smaller than the first range.

23. The method of claim 19, further comprising:
receiving user input via a hot key; and
in response to receiving the user input via the hot key, switching control of presentation of the rendered scene based on the first scaling profile to control of presentation of the rendered scene based on the second scaling profile.

24. The method of claim 19, further comprising:
receiving user input associating the first scaling profile with a first application program;
automatically controlling the first application based on the first scaling profile;
receiving user input associating the second scaling profile with a second application program; and
automatically controlling the second application based on the second scaling profile.
